(19) United States
(12) Patent Application Publication
(10) Pub. No.: US 2009/0025513 A1
(43) Pub. Date: Jan. 29, 2009

(54) Container Opener

(76) Inventor: Larry Salvino, Wauconda, IL (US)

Correspondence Address: VEDDER PRICE P.C., 222 N. LASALLE STREET, CHICAGO, IL, 60601, US

(21) Appl. No.: 11/829,681

(22) Filed: Jul. 27, 2007

(51) Int. Cl. B67B 7/16; B25F 1/00

(52) U.S. Cl. 81/3.57; 7/151

(57) ABSTRACT

A container opener providing a plurality of elements for opening various containers is disclosed. The opener is lightweight and has a one-piece construction that typically fits in a user's hand and pocket. The opener includes a handle portion, a mid-portion for containing a first element for opening containers, a distal end containing a second opening element and a third element placed on one side of the elongated opener.

### BACKGROUND OF THE INVENTION

1. Field of the Invention

This invention relates to a container opener having a plurality of elements for opening various types of containers.

2. Description of Related Art

There are a variety of conventional container openers designed to assist users in removing lids from a container by pulling or prying the lid off the container. Generally, individual openers are required for opening specific containers, for example, glass jars, bottles, canned food items, paint cans, plastic buckets or containers, etc. However, conventional openers do not provide convenient assistance to an individual who is performing similar tasks, such as opening cans of paint and plastic buckets as required by construction personnel, e.g., painters, plasterers, and wallboard hangers. Individual conventional openers do not provide a plurality of elements for opening more than one type of container.

### BRIEF SUMMARY OF THE INVENTION

In accordance with the present invention, there is provided a container opener configured for providing a plurality of elements for opening lids of various types of containers using one handheld device. The container opener provides elements for opening cans of paint, cylindrical containers, particularly large plastic containers that may hold joint compound, and an element for removing caps from bottles that contain beverages. The one-piece assembly includes a handle portion for gripping the opening, a midportion on the assembly having a first element with two opposed edges for opening a first container on one sidewall of the assembly, and a distal portion including a top having an opening with a second element including a plurality of edges for opening a second container. Another sidewall of the assembly contains an element for removing bottle caps from bottles.

### BRIEF DESCRIPTION OF THE SEVERAL VIEWS OF THE DRAWINGS

An embodiment of the present invention is described by way of example only with reference to the following drawings, in which

FIG. 1 is a perspective view showing a container opener illustrating a plurality of elements provided by the present invention;

FIG. 2 is a side view from the second sidewall of an embodiment of the present invention;

FIG. 3 is a side view from the fourth sidewall of an embodiment of the present invention;

FIG. 4 is a side view of the first sidewall of an embodiment of the present invention;

FIG. 5 is a side view of the third sidewall of an embodiment of the present invention;

FIG. 6 is a top view of an embodiment of the present invention; and

FIG. 7 is a bottom view of an embodiment of the present invention.

### DETAILED DESCRIPTION OF THE INVENTION

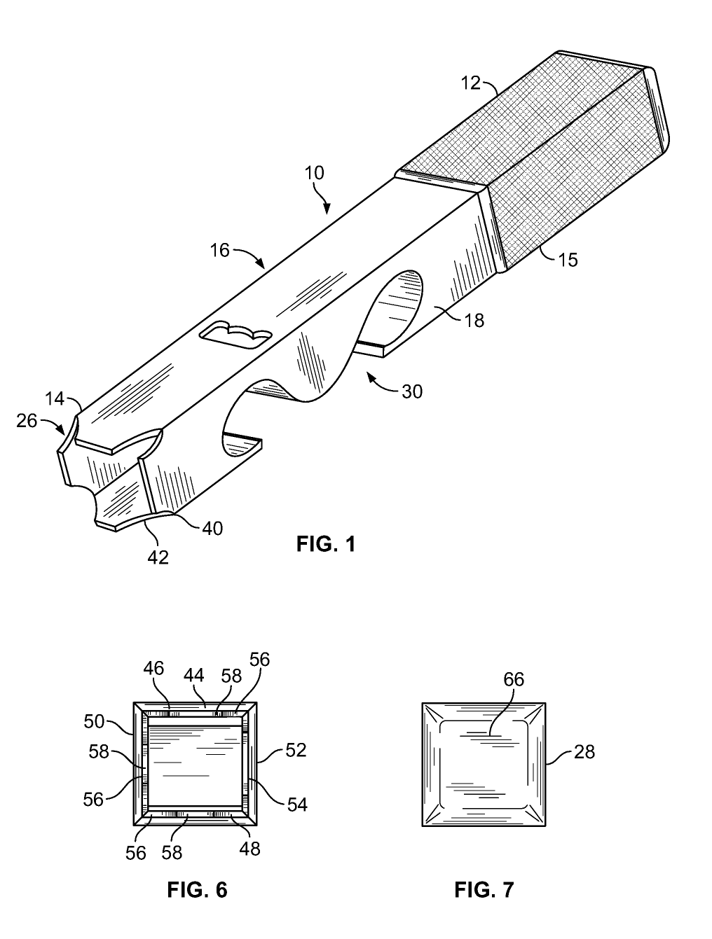

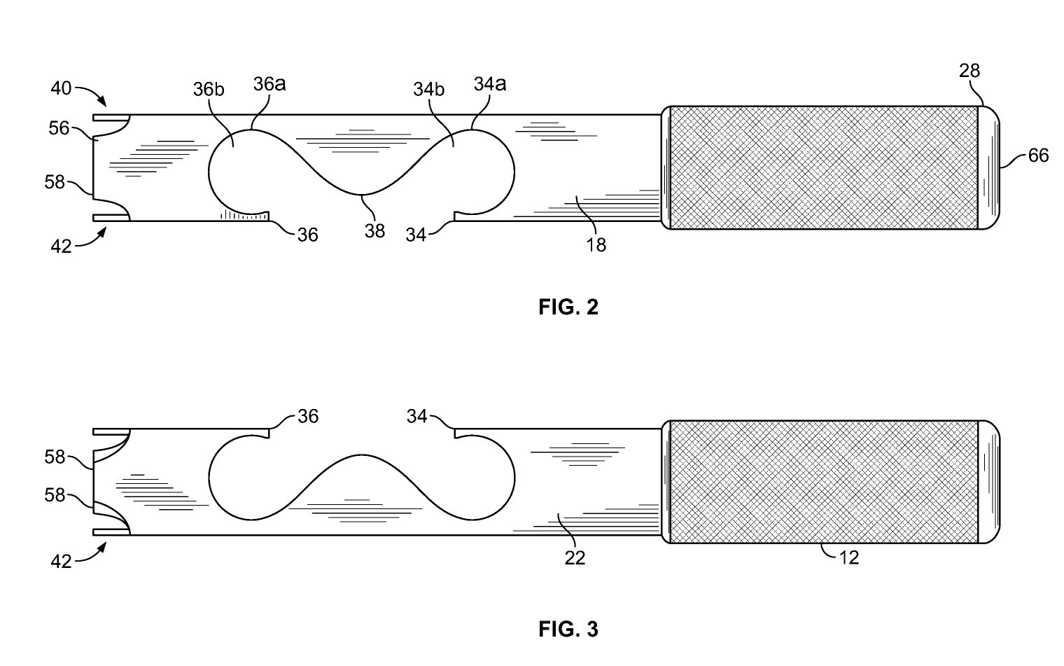

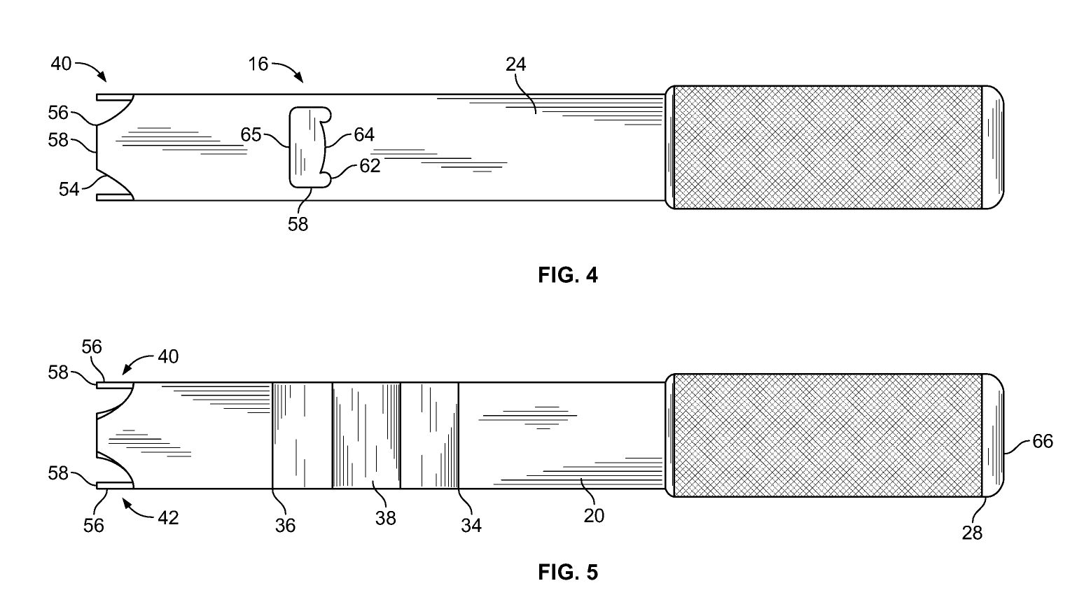

In accordance with the present invention, there is provided a tool configured to be a container opener for providing multiple elements for opening various containers. The container opener, generally designated as 10 as illustrated in FIGS. 1-6, is preferably used by a worker for opening a plurality of containers of materials required to perform activities on a construction site. An example of a material container, offered by way of example only, is a container holding paint for application to walls and ceilings of newly constructed sheetrock or wallboard. The opener with its plurality of opening elements may also be utilized to open others types of containers, such as five-gallon plastic containers having a cylindrical shape that hold joint compound. The joint compound is applied to sheetrock or wallboard and joint tape by a wallboard hanger. Once the wallboard or sheetrock is installed to form walls and ceilings, the wallboard or sheetrock is typically covered with a layer of paint obtained from a container that can also be opened by an opening element of container opener 10.

One embodiment of the container opener 10 includes an assembly having a handle 12 for gripping by the user. The elongated container opener 10 includes a distal end 14 and a midportion 16, both of which are longitudinally displaced in the same plane as handle 12. The assembly including handle 12, distal end 14, and midportion 16 is preferably generally rectangular in shape and sized to fit the hand of a user.

Container opener 10 is typically made from one of the following lightweight materials, with no intention of being limitative: steel, stainless steel, aluminum, or rigid plastic, polypropylene, such as a thermoplastic polymer, polypropylene, and engineering plastics. It may be produced with a hollow or solid core.

With reference to FIGS. 1-6, container opener 10 has first 18, second 20, third 22, and fourth 24 sidewalls positioned in a generally elongated rectangular configuration. The container opener 10 also includes top 26 at distal end 14, and bottom 28 adjacent handle 12.

A first opening element 30 is shown in FIGS. 1-3 and 5. Opening element 30 comprises a curvilinear configuration 32 in the first 18, second 20, and third 22 sidewalls. The opening element 30 is formed or sectioned from the aforementioned sidewalls at midportion 16 and includes a first edge 34 placed near the handle 12 at the proximal end 15 of the opener. Opposed to first edge 34 is second edge 36 positioned near the top 26 at distal end 14. Shoulder 38 is placed between the opposed edges 34 and 36 and may serve as a fulcrum for removing lids from containers. Pockets 34a and 36a extend upwardly and in an inverted “C” shape and meet at shoulder 38. The open spaces 34b and 36b allow for the top edge of a lid to fit therein, so the bottom edge of the lid may be engaged by either first 34 or second 36 edge. Once engagement of one of the edges, for example edge 34, is made with the lower edge of the container, handle 12 is lifted upwardly with the shoulder 38 contacting the top of the lid acting as a fulcrum or pivot to aid in the removal of the lid. The first container is typically a large plastic cylindrically-shaped container for holding various materials to be used at a construction worksite, for example, paint, joint compound, etc. The container may also be of the type for storing food items, metal articles, etc.

The operation can also be utilized when second edge 36 is placed on the lower edge or flange of a container lid so that shoulder 38 and handle 12 are positioned over the lid. The handle 12 is lifted upwardly or pushed downwardly so that edge 36 lifts the flange or lower edge of the lid away from and off the container.

Top 26 of container opener 10 includes container a second element 40 for opening a second container, for example, a paint can. Second element 40 includes a can opener 42 for opening paint cans and the like, which have lids that do not have flanges substantially overhanging the container edge. Conventionally, a tool must be fitted between the flange and raised outside ridge on the container to open the lid. In this regard, opener 42 has a general base 44 connected to each sidewall or integrally formed into the sidewall. Bases 46 and 48 are opposed to each other. Bases 50 and 52 are likewise opposed. Each base has a neck portion 54 leading to an operating edge 56, which has a straight edge 58 in order to engage the lid of a container. The edge 56 may also be curved or have a concave shape 58 can easily fit within the area between the lid and the container. Once fitted, handle 12 is pressed downwardly so that edge 56 lifts the lid from the container.

Fourth sidewall 24, generally at midportion 16 includes a third opening element 58, an elongated aperture 60 that is generally shaped as an opener 62. The opener 62 on one side has a curved bottom edge 64 for engaging the underside of a cap on a bottle and an opposed elongated top edge 65. Edge 64 may also be straight. One side of the cap fits within the aperture 60 so the lower edge of the cap engages curved edge 64. Once engaged onto the lower edge of a cap, the handle 12 is lifted to pry the cap from the bottle.

After a lid is removed from a container, the container can be resealed by aligning and fitting the lid on the container and striking the lid with bottom 28 of opener 10. Tap 66 is solidly constructed for applying pressure to a lid for closing the container.

The container opener 10 of the present invention provides a plurality of openers or elements for opening containers for facile use by an individual working with materials that are commonly used together at a construction site. Of course, other materials can be stored in containers which lids can be removed by the container opener, for example, food, metal articles, nails, screws, etc.

From the foregoing description, additional advantages over the prior devices are recognized by those skilled in the art for the container opener of the present invention. While a preferred embodiment is shown and described, it is understood that it is not intended to limit the disclosure of the invention, but rather, it is intended to cover all modifications and alternate devices and methods of operation falling within the spirit and scope of the invention as defined in the appended claims.

What is claimed is:

1. An opener for containers comprising:
a one-piece assembly having a first, second, third, and fourth sidewalls and a plurality of elements for opening a plurality of containers;
a handle portion on the assembly for gripping the opener;
a midportion on the assembly having a first element with two opposite edges for opening a first container; and
a distal portion including a top of the assembly including an opening with a second element with a plurality of edges for opening a second container.

2. The opener for containers of claim 1, wherein two opposite edges are positioned so that a first edge is proximate to the handle.

3. The opener for containers of claim 2, wherein the handle and the second edge is distal to the handle, each of the first and second edges of the first element is utilized to open a first container.

4. The opener for containers of claim 2, wherein a shoulder is positioned between the first and second edges.

5. The opener for containers of claim 4, wherein the shoulder serves as a fulcrum when the first or second edge engages a lid of the first container for removal.

6. The opener for containers of claim 1, wherein the second element comprises first and second opposed edges and third and fourth opposed edges.

7. The opener for containers of claim 6, wherein each of the opposed edges have a leading straight edge for engaging a lid to be removed from a container.

8. The opener for containers of claim 1, wherein the first element is positioned on the second, third, and fourth sidewalls of the one-piece assembly.

9. The opener for containers of claim 1, wherein the fourth sidewall of the container has an opener having a generally elongated opening with two opposed edges, and elongated top edge and a bottom edge defining a curved structure for engaging a lid of a container for removal.

10. The opener for containers of claim 9, wherein the container is a bottle.

11. The opener for containers of claim 1, wherein the assembly has a solid bottom adjacent the handle.
